(19) United States
(12) Patent Application Publication
(10) Pub. No.: US 2020/0402152 A1
(43) Pub. Date: Dec. 24, 2020

(54) SYSTEMS AND METHODS FOR PROVIDING CONTENT

(71) Applicant: Facebook, Inc., Menlo Park, CA (US)

(72) Inventor: Brian Paihan Sa, Irvine, CA (US)

(21) Appl. No.: 15/976,109

(22) Filed: May 10, 2018

(51) Int. Cl. G06Q 30/08; H04L 29/06; G06Q 30/06

(52) U.S. Cl. CPC G06Q 30/08; G06Q 30/0601; H04L 63/083

(57) ABSTRACT

Systems, methods, and non-transitory computer-readable media can initiate an auction provide content to a user. One or more bids are received from one or more bidders. A winning bid associated with a winning bidder is determined based on the one or more bids. The winning bidder is provided with a token authorizing the winning bidder to provide content to the user.

### FIELD OF THE INVENTION

The present technology relates to the field of content distribution. More particularly, the present technology relates to techniques for distributing content to users in a computer networking environment.

### BACKGROUND

Today, people often utilize computing devices (or systems) for a wide variety of purposes. Users can use their computing devices to, for example, interact with one another, access content, share content, and create content. In some cases, content items can include postings from members of a social networking system. The postings may include text and media content items, such as images, videos, and audio. The postings may be published to the social networking system for consumption by others.

Under conventional approaches, users may be provided with access to content on a social networking system. For example, content items posted by a first user can be included in the respective content feeds of other users of the social networking system that have “followed” the first user. In certain instances, content accessed on a social networking system can include notifications. For example, users may receive notifications notifying them of social networking system activity by other users, or notifications notifying them of upcoming events, and the like.

### SUMMARY

Various embodiments of the present disclosure can include systems, methods, and non-transitory computer readable media configured to initiate an auction to provide content to a user. One or more bids are received from one or more bidders. A winning bid associated with a winning bidder is determined based on the one or more bids. The winning bidder is provided with a token authorizing the winning bidder to provide content to the user.

In an embodiment, the one or more bids comprise a dummy bid generated by a dummy bidder that does not have content to provide to the user.

In an embodiment, If the winning bidder is the dummy bidder, the user is not provided with content as a result of the auction.

In an embodiment, a value of the dummy bid is automatically determined based on how many content items the user has received in a defined time period.

In an embodiment, the value of the dummy bid is automatically determined based further on how much time remains in the defined time period.

In an embodiment, the user is associated with a maximum number of content items that the user is permitted to receive within the defined time period.

In an embodiment, the token is associated with a time-to-live.

In an embodiment, a final bid value is deducted from a budget associated with the winning bidder.

In an embodiment, the final bid value is deducted from the budget associated with the winning bidder based on a determination that the winning bidder has utilized the token to provide a content item to the user.

In an embodiment, at least some of the one or more bids are determined based on at least one of a predicted click-through rate or a predicted conversion rate for the user.

In an embodiment, the auction is initiated based on a request from a first bidder of the one or more bidders.

In an embodiment, the auction is initiated based on a scheduled start time.

In an embodiment, the content is a notification.

In an embodiment, the one or more bidders comprise a plurality of entities, and each entity has a respective notification to provide to the user.

In an embodiment, the token and a first content item are received from the winning bidder.

In an embodiment, a determination is made that the token is valid to provide content to the user.

In an embodiment, the first content item is provided to the user based on the determination that the token is valid to provide content to the user.

In an embodiment, at least some of the one or more bids are modified based on budget pace values associated with each of the one or more bidders.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including a content provider module, according to an embodiment of the present disclosure.

FIG. 2 illustrates an example content auction module, according to an embodiment of the present disclosure.

FIG. 3 illustrates an example content delivery module, according to an embodiment of the present disclosure.

FIG. 4 illustrates an example sequence diagram associated with providing content to a user, according to an embodiment of the present disclosure.

FIG. 5 illustrates an example method, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Providing Content

People often utilize computing devices (or systems) for a wide variety of purposes. Users can use their computing devices to, for example, interact with one another, access content, share content, and create content. In some cases, content items can include postings from members of a social networking system. The postings may include text and media content items, such as images, videos, and audio. The postings may be published to the social networking system for consumption by others.

Under conventional approaches, users may be provided with access to content on a social networking system. For example, content items posted by a first user can be included in the respective content feeds of other users of the social networking system that have “followed” the first user. Users may also be provided with content that references other content on the social networking system. For example, users may be provided with notifications notifying them of content that may be interesting or relevant to the user. For example, users may receive notifications notifying them of social networking system activity by other users, or notifications notifying them of upcoming events, and the like.

Certain types of notifications may be time-sensitive. For example, a notification of a particular user's birthday may ideally occur on the actual date, since a notification after the fact would be less useful. Or, in another example, a notification of a particular user posting a live video stream may ideally be provided shortly after the live video stream has been initiated so that interested viewers can be made aware of and join the live video stream while it is occurring. As such, it can be appreciated that for at least certain types of notifications, a determination of whether or not to provide a user with a notification should be made in substantially real-time. Furthermore, it is generally understood that inundating users with too many notifications can be counterproductive, as it may lead to users ignoring future notifications or otherwise degrade user experience. As such, conventional approaches have attempted to limit the number of notifications users receive.

However, such conventional approaches can be problematic for various reasons. Different entities may have differing objectives for sending notifications to users. For example, a first entity (e.g., an events product team) may have the goal of sending notifications to users in order to increase user engagement with events posted to a social networking system, while a second entity (e.g., a live video stream product team) may have the goal of sending notifications to users in order to increase user engagement with live video streams posted to a social networking system. If a user is limited to receiving a certain maximum allowable number of notifications, once the user has received the maximum allowable number of notifications, the user may not be able to receive any further notifications. As such, given the large number of notifications that could potentially be sent to a user, a determination must be made as to which entities are permitted to send notifications to a particular user and which entities are not. Conventional approaches fail to provide an effective solution for how to balance the competing objectives of different entities.

Furthermore, in instances where a user is limited to receiving a certain number of notifications in a measuring period, a user may receive a large number of lower quality notifications earlier on in the measuring period and, consequently, may be unable to receive higher quality notifications that occur later on in the measuring period. Again, conventional approaches fail to provide an effective solution. While the example of notifications has been discussed above, such problems may be applicable to any kind of content being provided to a user. Accordingly, such conventional approaches may not be effective in addressing these and other problems arising in computer technology.

An improved approach rooted in computer technology overcomes the foregoing and other disadvantages associated with conventional approaches specifically arising in the realm of computer technology. In general, an auction conducted in a computerized communication network can be initiated to transmit content (i.e., electronic or digital content) to a particular user. In an embodiment, one or more bids can be transmitted by and received from a set of bidders. The set of bidders can include, for example, entities that may be interested in transmitting content to the user. For example, the set of bidders can include entities that may wish to provide a notification (e.g., an electronic notification) to the user. Each bidder may determine a bid value based on an importance of providing content to the particular user at the time of the auction. In this way, bidders that have a greater interest in providing content to the user may submit higher bids than other bidders that may not be as interested in providing content to the particular user at the time of the auction. A winning bidder can receive a token (e.g., an electronic token) that authorizes the winning bidder to provide content to the particular user. The token may be associated with a time-to-live, such that the token can only be used to provide content to the particular user within a time period defined by the time-to-live (e.g., the token must be used within 72 hours of the auction). When the winning bidder wishes to provide content to the user, the winning bidder can submit the content along with the token. If the token is verified, the content can be provided to the user.

In certain embodiments, a dummy bidder can be configured to submit dummy bids to auctions conducted in a computerized communication network. In an embodiment, if a dummy bid is the highest bid in an auction, no token is issued. As such, in such embodiments, if a dummy bid is the winning bid in an auction, none of the bidders obtain authorization to provide content to a user as a result of the auction. In certain embodiments, users may only be able to receive a certain amount of content in a given time period. For example, a user may only be able to receive ten notifications in a one-week period. The dummy bidder may be implemented in order to represent the benefit of leaving open the possibility of providing content to the user at a later time. For example, rather than allowing a user to receive ten notifications on the first day of a measuring period, such that the user can no longer receive any notifications for the remainder of the week, the dummy bidder can be implemented to pace notifications out more gradually over the week. In an embodiment, the value of the dummy bid can vary based on how many content items the user has received in a defined time period (e.g., in a current measuring period). In an embodiment, the value of the dummy bid can vary based on how much time remains in a defined time period (e.g., in a current measuring period). More details relating to the disclosed technology are provided below.

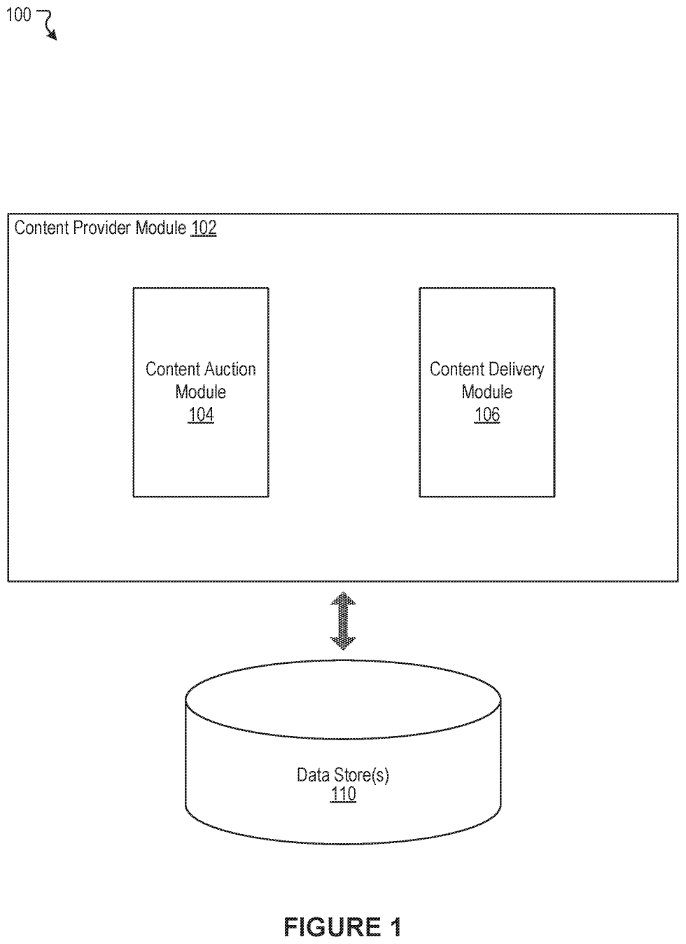

FIG. 1 illustrates an example system 100 including a content provider module 102, according to an embodiment of the present disclosure. As shown in the example of FIG. 1, the content provider module 102 can include a content auction module 104 and a content delivery module 106. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the content provider module 102 can be implemented in any suitable combinations.

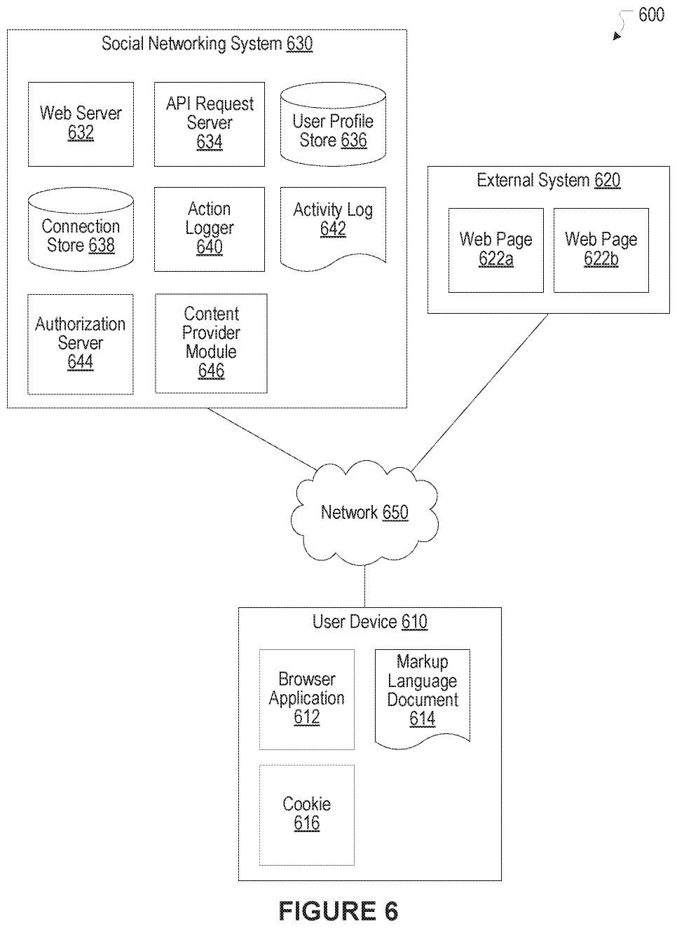

In some embodiments, the content provider module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the content provider module 102 can be, in part or in whole, implemented as software running on one or more computing devices or systems, such as on a server system or a client computing device. In some instances, the content provider module 102 can be, in part or in whole, implemented within or configured to operate in conjunction with or be integrated with a social networking system (or service), such as a social networking system 630 of FIG. 6. Likewise, in some instances, the content provider module 102 can be, in part or in whole, implemented within or configured to operate in conjunction with or be integrated with a client computing device, such as the user device 610 of FIG. 6. For example, the content provider module 102 can be implemented as or within a dedicated application (e.g., app), a program, or an applet running on a user computing device or client computing system. The application incorporating or implementing instructions for performing functionality of the content provider module 102 can be created by a developer. The application can be provided to or maintained in a repository. In some cases, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

The content provider module 102 can be configured to communicate and/or operate with the at least one data store 110, as shown in the example system 100. The data store 110 can be configured to store and maintain various types of data. In some implementations, the data store 110 can store information associated with the social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data.

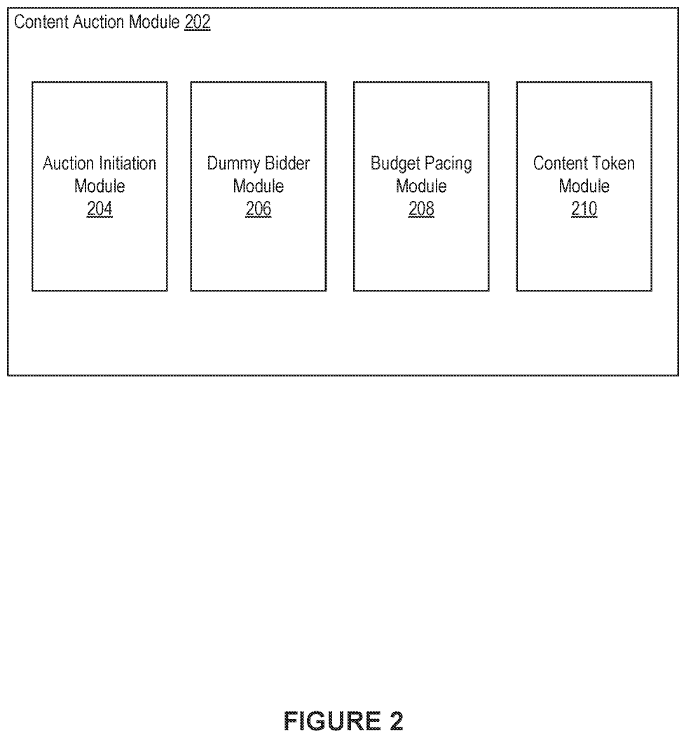

The content auction module 104 can be configured to implement an auction to provide content to a user. In an embodiment, the auction may be, for example, a Vickrey-Clarke-Groves (VCG) auction. In various embodiments, the content auction module 104 can initiate an auction based on a scheduled start time or based on a request from an entity, such as a bidder. In an embodiment, the content auction module 104 can provide a winning bidder of an auction with a digital token that authorizes the winning bidder to provide content to a user. More details regarding the content auction module 104 will be provided below with reference to FIG. 2.

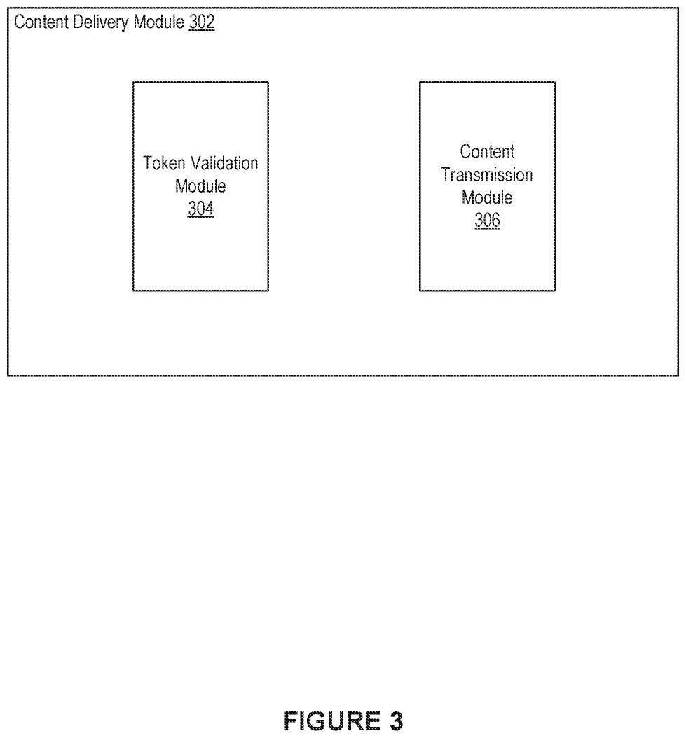

The content delivery module 106 can be configured to deliver content to a user. In an embodiment, the content delivery module 106 can receive from an entity a content item to be delivered to a particular user, as well as a digital token that authorizes the entity to provide content to the particular user. The content delivery module 106 can verify that the digital token is valid to provide content to the particular user before delivering the content item. More details regarding the content delivery module 106 will be provided below with reference to FIG. 3.

FIG. 2 illustrates an example content auction module 202 according to an embodiment of the present disclosure. In some embodiments, the content auction module 104 of FIG. 1 can be implemented as the content auction module 202. As shown in the example of FIG. 2, the content auction module 202 can include an auction initiation module 204, a dummy bidder module 206, a budget pacing module 208, and a content token module 210.

The auction initiation module 204 can be configured to initiate an auction to provide content to a particular user. Each auction initiated by the auction initiation module 204 can be associated with a particular user, such that a winner of the auction is provided with an authorization (e.g., a token) to provide content to the user. For example, a winner of a first auction may be given authorization to provide one piece of content or content item (e.g., one notification) to a first user, a winner of a second auction may be given authorization to provide one piece of content or content item (e.g., one notification) to a second user, and so forth. In certain embodiments, the auction initiation module 204 can initiate an auction based on a request from an entity (e.g., a bidder). For example, a first entity may wish to provide content to a first user. The first entity can submit a request to initiate an auction with respect to the first user. The auction initiation module 204 can initiate an auction to provide content to the first user in response to the first entity's request. In certain embodiments, the auction initiation module 204 can initiate an auction based on a scheduled auction time. For example, auctions can be periodically scheduled (e.g., once every Tuesday and once every Friday) to provide a user with content. Various embodiments can accommodate both bidder-initiated auctions and scheduled auctions.

Once an auction to provide content to a particular user has been initiated, the auction initiation module 204 can solicit bids from one or more bidders. In an embodiment, the auction initiation module 204 can solicit bids from each bidder in a set of bidders. Bidders that do not have content to provide to the user, or that are not interested in providing content to the user, can submit a zero bid or some other null value. Other bidders that are interested in providing content to the user can submit bids. Each bidder can determine a bid value for their bid. In this way, each entity is tasked with determining how much value they place on providing content to the particular user associated with the auction at the time of the auction. For example, a first entity that has a significant interest in providing content to the user can submit a relatively high bid, while a second entity that has minimal interest in providing content to the user can submit a relatively low bid. In certain embodiments, one or more bidders (e.g., one or more entities) can determine bid values, at least in part, based on a predicted click-through rate (CTR) and/or a predicted conversion rate (CVR) with respect to the particular user associated with the auction. For example, consider an example scenario in which a live video stream product team would like to provide a first user with a notification indicating that a first friend of the first user is streaming a live video. In response to a request from the live video stream product team, the auction initiation module 204 can initiate an auction for providing content to the first user. The auction initiation module 204 can solicit bids from one or more bidders. The auction initiation module 204 can receive a first bid from the live video stream product team. A value of the first bid may have been determined by the live video stream product team based on an expected click-through rate or expected conversion rate for the first user to access the live video stream by the first friend. The auction initiation module 204 can also receive a second bid from an events product team to provide the first user with a notification notifying the user of an event that may be of interest to the first user. A value of the second bid may be determined by the events product team based on an expected click-through rate or expected conversion rate for the first user to view and/or attend the event.

The dummy bidder module 206 can be configured to implement a dummy bidder to participate in auctions for providing content to users. In an embodiment, the dummy bidder module 206 can be configured to submit a dummy bid into every auction (or selected auctions) initiated by the auction initiation module 204. As mentioned above, the dummy bidder can be implemented in order to provide some measure of pacing for providing content to users. As discussed, in certain embodiments, each user may be limited to receiving a defined maximum number of content items over a particular period of time. For example, a particular user may be limited to receiving only ten notifications a week. In an embodiment, a value of the dummy bid submitted by the dummy bidder module 206 can be automatically (e.g., algorithmically) determined by the dummy bidder module 206. In an embodiment, a value of the dummy bid submitted by the dummy bidder module 206 can vary based on a number of content items a user has received in a defined time period (e.g., a current measuring period). For example, the value of the dummy bid may change with (e.g., be proportional to) the number of notifications received by the user in a measuring period. In this regard, in one implementation, if a user is permitted to receive ten notifications in one week, for each notification the user receives that week, the value of the dummy bid may increase. In an embodiment, a value of the dummy bid submitted by the dummy bidder module 206 can vary further based on a remaining amount of time in a defined time period (e.g., a current measuring period). For example, the value of the dummy bid may change with (e.g., be proportional to) the remaining amount of time in a measuring period. In this regard, in one implementation, if a user is permitted to receive ten notifications in one week, as the week passes, the value of the dummy bid may gradually decrease. In a further example, if a user receives two notifications on the first day of the measuring period (e.g., the first day of the measuring week), the value of the dummy bid may increase. If the user does not receive any further notifications for the next 3 days, the value of the dummy bid may gradually decrease, and then increase again when the user receives another notification, and so forth.

The budget pacing module 208 can be configured to generate modified bid values by modifying preliminary bids submitted by bidders. As mentioned above, the auction initiation module 204 can be configured to solicit bids from one or more bidders to provide content to a particular user. The bids can include a dummy bid by a dummy bidder, as well as additional bids from various entities that may have varying levels of interest in providing content to the particular user. In certain embodiments, bids submitted by bidders may be treated as preliminary bids, and may be adjusted by the budget pacing module 208. In certain embodiments, a content platform, such as a social networking system, can define content budgets for each content type of a plurality of content types. For example, the social networking system may specify that an events team has a budget of $50,000/day to provide event notifications to users, and a live video stream team has a budget of $10,000/day to provide live video stream notifications to users. In order to ensure that these target budgets are being utilized effectively, the budget pacing module 208 can modify preliminary bids for various content types based on a remaining budget for each content type and a remaining amount of time in a measuring period at the time of an auction. For example, each bidder can be associated with a content type, and each bidder may be associated with a particular budget. For example, as discussed above, an events team may be associated with an “events notification” content type, and the events team may be assigned a budget for providing events notifications to users. If a particular bidder is below a target pace (e.g., a budget pace value for the bidder is below a target value), the budget pacing module 208 can increase the preliminary bid submitted by the bidder. If a particular bidder is above a target pace (e.g., a budget pace value for the bidder is above a target value), the budget pacing module 208 can decrease the preliminary bid submitted by the bidder. The budget pacing module 208 can increase or decrease preliminary bids, for example, by applying a multiplier to a preliminary bid.

For additional clarification, consider an example scenario in which there are two types of notifications: event notifications and live video stream notifications. A social networking system, or administrator thereof, has specified that an events team has a budget of $100,000/day to provide event notifications to users, and a live video stream team also has a budget of $100,000/day to provide live video stream notifications to users. At the time of a first auction, the events team may be above pace (e.g., $75,000 spent in the first 12 hours of a 24-hour period) and the live video stream team may be below the target pace (e.g., $25,000 spent in the first 12 hours of a 24-hour period). The events team can submit a bid for the first auction, and the live video stream team can also submit a bid for the first auction. The budget pacing module 208 can modify both bid values based on budget pace values for each team and their respective content types. In this example scenario, the budget pacing module 208 can decrease the bid value submitted by the events team for the event notification because the events team has spent $75,000 of its $100,000 budget when it would be expected to have spent $50,000 if spending is to be evenly distributed over time. Similarly, the budget pacing module 208 can increase the bid value submitted by the live video stream team for the live video stream notification because the live video stream team has spent only $25,000 of its $100,000 budget when it would be expected to have spent $50,000 if spending is to be evenly distributed over time.

The content token module 210 can be configured to determine a winner of an auction and award the winner of the auction with a token that authorizes the auction winner to provide content to a particular user. In an embodiment, the token may have a time-to-live, or an expiration date or time, such that the token must be used within a prescribed time period. For example, a token may authorize a winning bidder to provide content to a particular user within 72 hours. In various embodiments, the winner of an auction may be determined based on bid values of bids submitted by various bidders. In various embodiments, bid values used to determine an auction winner may be modified bid values that have been modified by the budget pacing module 208.

Once a winning bidder has been determined, the content token module 210 can deduct a final bid value from the budget of the winning bidder. In various embodiments, the final bid value may be equal to the value of the bid submitted by the winning bidder, the final bid value may be equal to the modified bid value of the winning bidder as determined by the budget pacing module 208, or the final bid value may be a different value determined based on bid values and/or modified bid values from the various bidders. For example, in VCG auctions, the final bid value may be determined based on the bid values (and/or modified bid values) from all of the bidders in an auction. In certain embodiments, the final bid value may be deducted from a winning bidder's budget only after the awarded token is actually utilized by the winning bidder. In other embodiments, the final bid value may be deducted from the winning bidder's budget regardless of whether or not the awarded token is utilized. In an embodiment, a particular bidder (e.g., particular entity) may hold only one token at a time in order to prevent hoarding of tokens, and to incentivize prompt use of tokens. As mentioned, in certain embodiments, a dummy bidder may submit a dummy bid for each auction. If the content token module 210 determines that a dummy bid is the winning bid, a token is not issued.

FIG. 3 illustrates an example content delivery module 302 according to an embodiment of the present disclosure. In some embodiments, the content delivery module 106 of FIG. 1 can be implemented as the content delivery module 302. As shown in the example of FIG. 3, the content delivery module 302 can include a token validation module 304 and a content transmission module 306.

The token validation module 304 can be configured to receive and validate a token for providing content to a particular user. In an embodiment, a bidder that has won an auction associated with a particular user can submit content to be provided to the user along with a token received from the auction. The token validation module 304 can determine (e.g., validate) that the token is valid before providing content to the user. For example, the token validation module 304 can confirm that the token has not expired. As another example, the token validation module 304 can confirm the identity of the bidder.

The content transmission module 306 can be configured to transmit content to a user based on the token validation module 304 determining that a token is valid. For example, as discussed above, if an entity submits a request to provide a notification to a user, the entity can submit a token along with the request. The token validation module 304 can check to ensure that the token is valid. If the token is validated, the content transmission module 306 can provide the notification to the user. If the token is not validated, the content transmission module 306 does not provide the notification to the user.

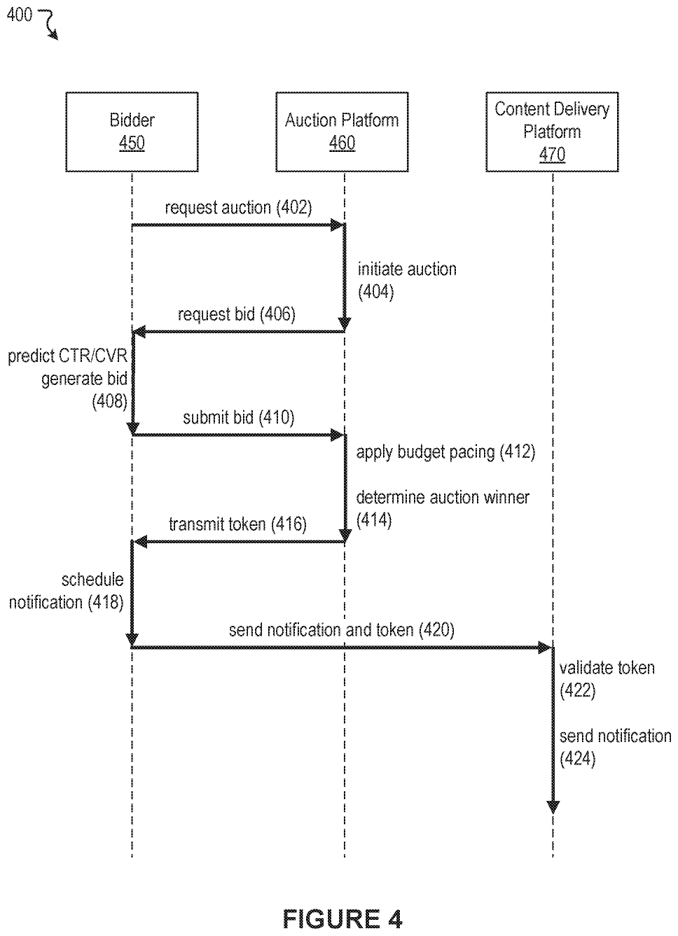

FIG. 4 illustrates an example sequence diagram 400 associated with providing content to a user, according to an embodiment of the present disclosure. The example sequence diagram 400 illustrates an example set of interactions between a bidder 450, an auction platform 460, and a content delivery platform 470. In an embodiment, the auction platform 460 may be implemented, for example, using the content auction module 104 of FIG. 1, and the content delivery platform 470 may be implemented, for example, using the content delivery module 106 of FIG. 1. In some embodiments, the auction platform 460 and the content delivery platform 470 can be implemented in an integrated platform. It should be appreciated that while the sequence diagram 400 depicts a particular set of steps in a particular order by a particular set of users, there can be additional, fewer, or alternative steps performed, in similar or alternative orders, or in parallel, and such steps may be performed by more or fewer users, within the scope of the various embodiments discussed herein unless otherwise stated.

At step 402, the bidder 450 submits a request to initiate an auction with respect to a particular user. At step 404, the auction platform 460 initiates an auction to provide content to the particular user. At step 406, the auction platform 460 solicits bids from a set of bidders, including the bidder 450. At step 408, the bidder 450 generates a bid. In an embodiment, the bid is generated based on a predicted CTR and/or a predicted CVR with respect to the particular user. At step 410, the bidder 450 submits the bid. At step 412, the auction platform 460 applies budget pacing to increase or decrease the bid submitted by the bidder 450. In an embodiment, the bid may be increased or decreased based on whether the bidder 450 is above or below a target budget pace value at the time of the auction. At step 414, the auction platform 460 determines an auction winner. In the example sequence diagram 400, the bidder 450 is determined to be the winner of the auction. At step 416, the auction platform 460 transmits a token to the bidder 450. At step 418, the bidder 450 schedules a notification to be sent to the particular user. At step 420, the bidder 450 sends the content delivery platform 470 a notification to be sent to the particular user along with the token the bidder 450 received as a result of winning the auction. At step 422, the content delivery platform 470 validates the token, and at step 424, the content delivery platform 470 delivers the notification to the particular user.

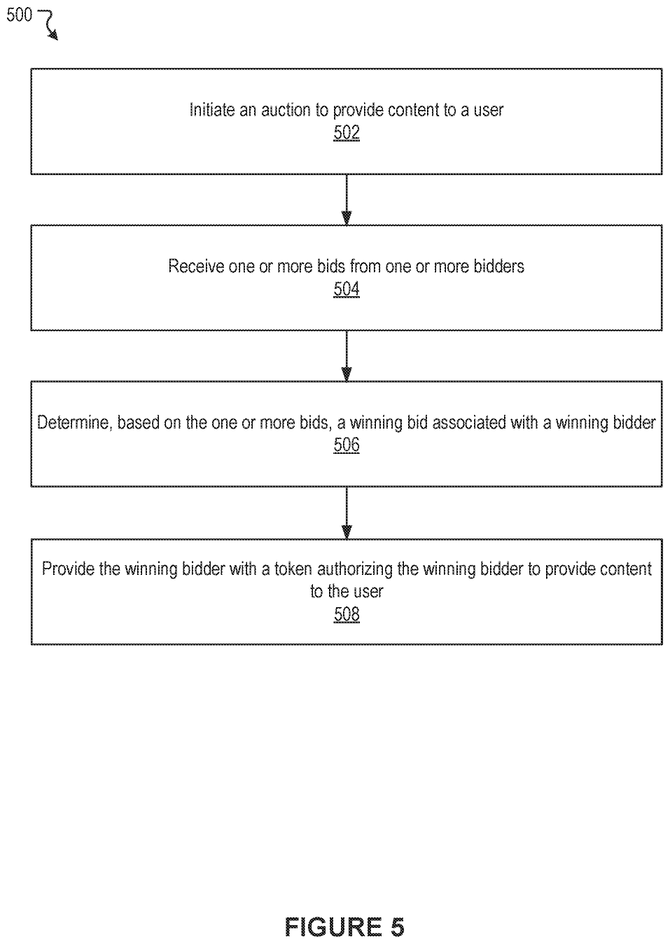

FIG. 5 illustrates an example method 500 associated with providing content to a user, according to an embodiment of the present disclosure. It should be appreciated that there can be additional, fewer, or alternative steps performed in similar or alternative orders, or in parallel, within the scope of the various embodiments discussed herein unless otherwise stated.

At block 502, the example method 500 can initiate an auction to provide content to a user. At block 504, the example method 500 can receive one or more bids from one or more bidders. At block 506, the example method 500 can determine, based on the one or more bids, a winning bid associated with a winning bidder. At block 508, the example method 500 can, provide the winning bidder with a token authorizing the winning bidder to provide content to the user.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, according to an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a content provider module 646. The content provider module 646 can, for example, be implemented as the content provider module 102, as discussed in more detail herein. In some embodiments, one or more functionalities of the content provider module 646 can be implemented in the user device 610. As discussed previously, it should be appreciated that there can be many variations or other possibilities.

### Hardware Implementation

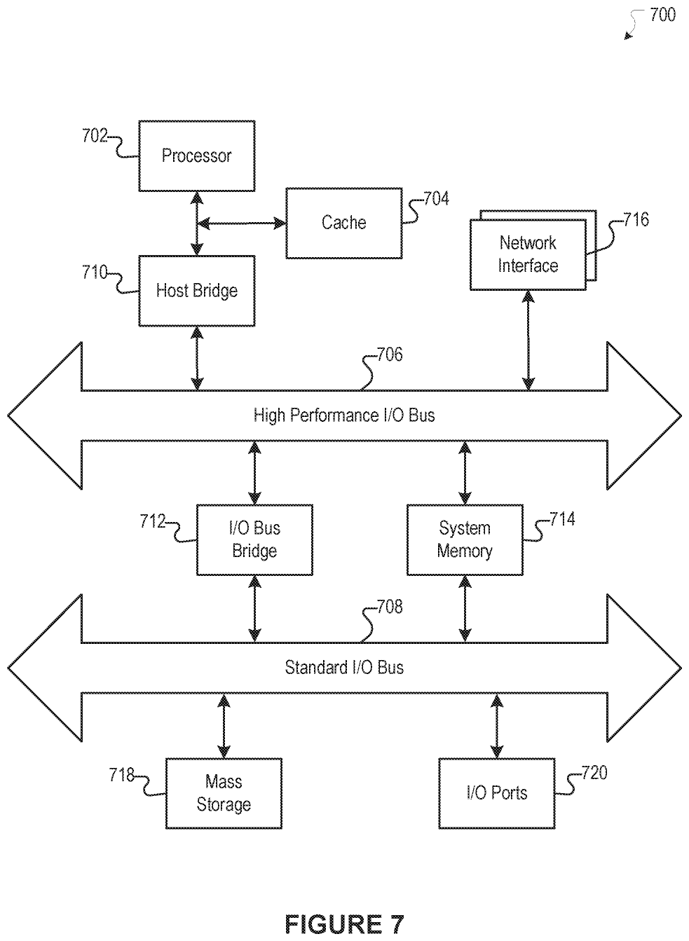

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method comprising:
initiating, by a computing system, an auction to provide content to a user;
receiving, by the computing system, one or more bids from one or more bidders;
determining, by the computing system, based on the one or more bids, a winning bid associated with a winning bidder;
providing, by the computing system, the winning bidder with an electronic token authorizing the winning bidder to provide content to the user;
receiving, by the computing system, from the winning bidder, the electronic token and content associated with the electronic token;
verifying, by the computing system, the electronic token; and
providing, by the computing system, the content associated with the electronic token to the user.

2. The computer-implemented method of claim 1, wherein
the one or more bids comprise a dummy bid generated by a dummy bidder that does not have content to provide to the user.

3. The computer-implemented method of claim 2, wherein if the winning bidder is the dummy bidder, the user is not provided with content as a result of the auction.

4. The computer-implemented method of claim 3, wherein a value of the dummy bid is automatically determined based on how many content items the user has received in a defined time period.

5. The computer-implemented method of claim 4, wherein the value of the dummy bid is automatically determined based further on how much time remains in the defined time period.

6. The computer-implemented method of claim 4, wherein the user is associated with a maximum number of content items that the user is permitted to receive within the defined time period.

7. The computer-implemented method of claim 1, wherein the electronic token is associated with a time-to-live.

8. The computer-implemented method of claim 1, further comprising deducting a final bid value from a budget associated with the winning bidder.

9. The computer-implemented method of claim 8, wherein the final bid value is deducted from the budget associated with the winning bidder based on a determination that the winning bidder has utilized the electronic token to provide a content item to the user.

10. The computer-implemented method of claim 1, wherein at least some of the one or more bids are determined based on at least one of a predicted click-through rate or a predicted conversion rate for the user.

11. A system comprising:
at least one processor; and
a memory storing instructions that, when executed by the at least one processor, cause the system to perform a method comprising:
initiating an auction to provide content to a user;
receiving one or more bids from one or more bidders;
determining, based on the one or more bids, a winning bid associated with a winning bidder;
providing the winning bidder with an electronic token authorizing the winning bidder to provide content to the user;
receiving, from the winning bidder, the electronic token and content associated with the electronic token;
verifying the electronic token; and
providing the content associated with the electronic token to the user.

12. The system of claim 11, wherein the auction is initiated based on a request from a first bidder of the one or more bidders.

13. The system of claim 11, wherein the auction is initiated based on a scheduled start time.

14. The system of claim 11, wherein the content is a notification.

15. The system of claim 14, wherein the one or more bidders comprise a plurality of entities, and each entity has a respective notification to provide to the user.

16. A non-transitory computer-readable storage medium including instructions that, when executed by at least one processor of a computing system, cause the computing system to perform a method comprising:
initiating an auction to provide content to a user;
receiving one or more bids from one or more bidders;
determining, based on the one or more bids, a winning bid associated with a winning bidder; and
providing the winning bidder with an electronic token authorizing the winning bidder to provide content to the user;
receiving, from the winning bidder, the electronic token and content associated with the electronic token;
verifying the electronic token; and
providing the content associated with the electronic token to the user.

17. The non-transitory computer-readable storage medium of claim 16, wherein
the content associated with the electronic token is a first content item to provide to the user.

18. (canceled)

19. The non-transitory computer-readable storage medium of claim 17, wherein
the first content item is provided to the user based on the determining that the electronic token is valid.

20. The non-transitory computer-readable storage medium of claim 16, wherein the instructions, when executed by the at least one processor of the computing system, further cause the computing system to perform:
modifying at least some of the one or more bids based on budget pace values associated with each of the one or more bidders.
